(19) United States
(12) Patent Application Publication
(10) Pub. No.: US 2004/0015719 A1
(43) Pub. Date: Jan. 22, 2004

(54) Intelligent security engine and intelligent and integrated security system using the same

(76) Inventors: Dae-Hyung Lee, Seoul (KR); Sung-Chul Kim, Seoul (KR); Du-Cheon Ryu, Seoul (KR)

Correspondence Address: Robert E. Bushnell, Suite 300, 1522 K Street, N . W ., Washington, DC, 20005, US

(21) Appl. No.: 10/195,326

(22) Filed: Jul. 16, 2002

(51) Int. Cl. G06F 11/30; G06F 15/173

(52) U.S. Cl. 713/201; 709/224

(57) ABSTRACT

A firewall interconnects and controls access between external and internal networks, and a plurality of security agents monitor a data flow and system calls over the internal network. An intelligent security engine (ISE) is for analyzing an alert message, a traffic information and an event information transferred from the plurality of security agents to decide if there is an attack and to generate a signature through a learning process. A security policy manager (SPM) is for managing and applying a security policy to each of the plurality of security agents based on the decision of the ISE. The ISE performs a correlation analysis and a causation analysis on suspicious traffic and events and a detection message transferred from the plurality of security agents. Further, the ISE carries out a pattern analysis and generates a new detection pattern through a self-learning process.

### BACKGROUND OF THE INVENTION

1. Technical Field of the Invention

The present invention relates generally to network security protection, and more particularly, the present invention relates to intelligent and integrated security systems in which individual security agents are actively inter-related.

The invention is related to the subject matter contained in Korean Patent Application Ser. No. 2000-73471, filed by the subject assignee on Dec. 15, 2000, entitled Intelligent Security System for Network Based on Agents, which is incorporated herein by reference.

2. Description of Related Art

The network environment of computer networks, such as the Internet, provides an open and transparent communication network for users located remotely. Computers on the network exhibit both universality and binary logic for computing. Universality means that the computers themselves are not task oriented, and instead they are programmed to perform various tasks depending on the implemented program. This feature of computers facilitates computing networks, but it also presents challenges as to security issues, because anything which can be programmed, may also be programmed to perform malicious activities within the network. In addition, binary logic makes the precise detection of abnormal activities even more difficult.

Generally, network security is largely concerned with (a) information security, i.e., protecting information from unauthorized disclosure, (b) information integrity, i.e., protecting information from unauthorized modification or destruction, and \mathring{c}) ensuring the reliable operation of the computing and networking resources. Encryption is often used to improve information security and information integrity, and maybe applied at each layer of the network and implemented with software and hardware. On the other hand, ensuring the reliable operation of computing and networking resources is a more difficult task. The precise detection of intruders or attackers in real-time is highly important in maintaining both network security and host security. However, in current network systems where tremendous numbers of computers are interconnected, it is difficult to monitor all the data flowing over the network, and to react in real-time in response to abnormal conditions and/or detected intrusions or attacks.

Further, recent intrusions have evolved which characterized by an increase of coordinated simultaneous attacks from different locations and to a combination of attacks and viruses. Moreover, new types of attacks have rapidly increased and conventional attacking schemes have been merged into various new forms. Further, the current trend of integrating wired communication links and wireless telecommunication networks effectively collapses the peculiar communication characteristics of differing technologies, and there is therefore a need for new information security concepts, which are suitable for changing network environments.

In addition, conventional security systems have a great number of nodes within the network, and hence, when the security system operates, the performance of the overall network is degraded, and coordination or integration of individual security products is not easy to implement.

### SUMMARY OF THE INVENTION

An object of this invention is to provide an intelligent security engine, and an intelligent and integrated security system, which are suitable for use in current information and telecommunication environments, and which are capable of properly confronting new types of attacks and intrusions.

Another object of this invention is to provide an intelligent and integrated security system which can precisely detect intrusions and take real-time measures in response to the detected intrusions.

Yet another object of this invention is to integrally operates individual and separate security products and to improve the efficiency of information security.

Still another object of this invention is to implement a distributed security environment based on a number of independent security agents without degrading network performance.

According to one aspect of the present invention, an intelligent and integrated security system includes a firewall interconnecting and controlling access between external and internal networks; a plurality of security agents monitoring a data flow and system calls over the internal network; an intelligent security engine (ISE) for analyzing an alert message, a traffic information and an event information transferred from the plurality of security agents to decide if an attack is occurring and to generate a signature through a learning process; and a security policy manager (SPM) for managing and applying a security policy to each of the plurality of security agents based on the decision of the ISE.

The ISE performs a correlation analysis and a causation analysis on suspicious traffic and events and on a detection message transferred from the plurality of security agents. Further, the ISE includes a pattern analysis module including a pre-processor for data-transforming an audit produced from the plurality of security agents, a pattern analyzer for analyzing the transformed audit data and generating new pattern and model, and a detector for detecting an intrusion based on the generated model. The plurality of security agents may include a network security agent (NSA) for analyzing suspicious traffic and providing a network security function, a host security agent (HSA) for reacting to threats associated with resources of a server within the network, and a firewall security agent (FSA) for adopting a security policy transferred from the SPM and causing the firewall to block a traffic from an attacker.

According to other aspect of the present invention, the intelligent and integrated security system includes a security center for verifying the new signature generated by the ISE, and the verified signature may be applied to a remotely located FSA for a firewall that belongs to a remote external network.

According to another aspect of the present invention, an intelligent security engine includes means for receiving all reduced form of traffics and events from a security agent and receiving a suspicious traffic and event from the security agent; means for performing a correlation analysis to the suspicious traffic and event received by the receiving means; a pattern analysis module for analyzing patterns of all the reduced form of traffics and events received by the receiving means; means for generating a new signature based on the results of correlation analysis, the causation analysis and the pattern analysis; means for deciding if an attack is occurring based on the results of correlation analysis, the causation analysis and the pattern analysis; and means for transferring the decision and the new signature to a security policy manager.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompajying drawings in which like reference symbols indicate the same or similar components, wherein:

These and other features and advantages of the invention will become readily apparent from the detailed description that follows, with reference to accompanying drawings, in which:

FIG. 1 is a block diagram showing an overall configuration of an intelligent security system according to an embodiment of the present invention;

FIG. 2 shows an operational flow of an intelligent security system with an active cooperation of a plurality of independent agents;

FIG. 3 illustrates a clustering process in a learning process of a new pattern of attacks;

FIG. 4 is a block diagram for showing functions and operations of an intelligent security engine suitable for use in the embodiment of the present invention;

FIG. 5 is a block diagram for illustrating functions and operations of a security policy manager suitable for use in the intelligent and integrated security system according to an embodiment of the present invention;

FIG. 6 is a block diagram showing a data flow in a pattern analysis process on security information;

FIG. 7 is a block diagram for illustrating a data flow during a security information pattern analysis;

FIG. 8 is a block diagram for showing a data flow when a correlation analysis is carried out;

FIG. 9 is a block diagram for illustrating an exemplary detection procedure by using the correlation analysis of an embodiment of the present invention;

FIG. 10 is a block diagram for showing a data flow during a causation analysis of an embodiment of the present invention;

FIG. 11 is a bock diagram for illustrating an exemplary detection procedure by using the causation analysis of an embodiment of the present invention; and

FIG. 12 illustrates a remote signature updating process according to an embodiment of the present invention.

### DETAILED DESCRIPTION OF PREFERRED EMBODIMENTS

Embodiments of the present invention will now be described in detail below. Herein, the terms ‘intrusion’ and ‘attack’ denote a set of one or more invasive, invalid and destructive activities or events challenging information integrity, confidentiality and availability, and the phrase ‘intrusion detection’ denotes software, hardware and a combination thereof that can monitor and react against illegal and unauthorized attempts to use system resources by outsiders and against misuse or abuse of insiders.

System Configuration

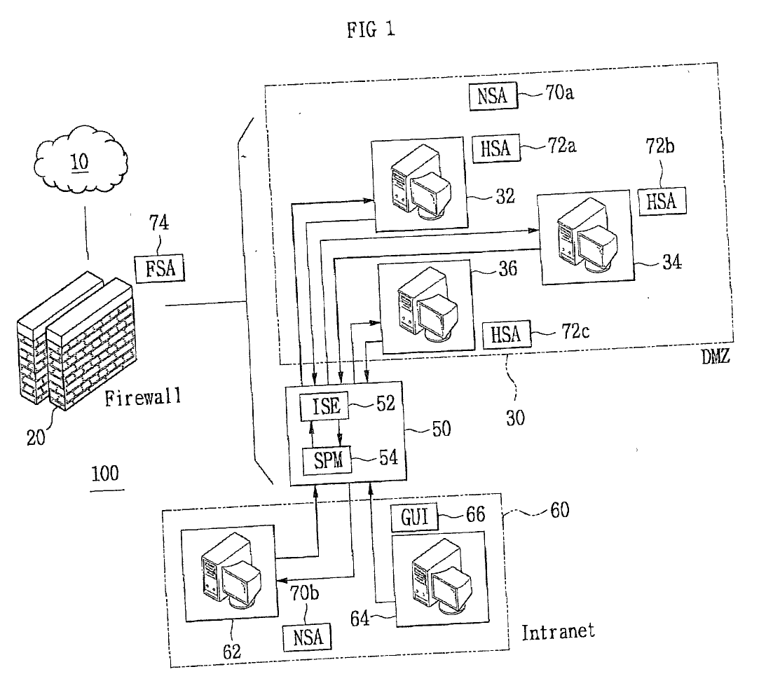

FIG. 1 illustrates the hardware configuration of and functional relationship among components in an intelligent security system of the present invention.

The intelligent security system 100 operates within a computer system interconnected by a network. A public network 10 is an open and transparent network, e.g., the Internet, based on communication protocols including TCP (Transmission Control Protocol), UDRP (User Datagram Protocol), IP (Internet Protocol) and ARP (Address Resolution Protocol). The connection to and from the outside public network 10 is made via a firewall 20. The firewall 20 is a set of associated programs located in a network gateway server and protects resources of the internal network from outside users. The firewall 20 prevents accesses from outsiders to internal resources that must not be opened, and controls accesses of insiders to external resources. The firewall 20 confirms if requests of an outsider are from permitted domain names or IP addresses and typically includes a graphic user interface (GUI) for enhanced control of network access and for advanced security features related to intrusion and statistics on network uses and security policy enforcement.

FIG. 1 shows that a secure network is connected to an insecure outside world via the firewall 20. However, it is possible to provide a screening router exterior to the firewall 20. The exterior screening router acts as a first-level filter to permit or deny traffic coming in from the Internet to the internal world. The screening router validates most incoming traffic before passing it to the firewall 20. The firewall 20 then provides the more CPU-intensive function of packet-by-packet inspection. An internal network secured by the firewall 20 includes a DMZ (De-Militarized Zone) 30 and an intranet 60.

The DMZ 30 is an area for providing public information, and customers or outsiders can obtain the information that they need through the DMZ 30 without directly accessing the internal network. Internal information and data are stored behind the DMZ 30 on the intranet 60. The DMZ 30 includes server systems for accessing from the outside of the firewall 20, which include a mail server 32 relaying outside mail to the inside, a web server 34 holding public information and an authentication server 36. Services like HTTP for general public usage, secure SMTP, secure FTP, and secure Telnet may be deployed on the DMZ. All incoming HTTP connections headed for the internal network are blocked by the firewall 20, and outsiders cannot surf the intranet 60. Once the outside HTTP is blocked, insiders can then safely deploy web servers 34 solely for internal use. To build the DMZ 30, the firewall 20 needs to have three network interfaces: one goes to the inside of the intranet; one goes to the unsecured external network 10; and the third goes to the DMZ 30.

To the servers 32, 34 and 36 in the DMZ area 30, security agents HSAs (Host Security Agents) 72a, 72b and 72c are installed. NSA (Network Security Agent) 70a is installed within the DMZ network segment 30. If HSAs are situated within all the DMZ servers, it is possible to omit the NSA 70a. It is preferable to install NSA 70 in a place where both the traffic within the internal network and incoming traffic from the external network can be monitored.

The intranet 60 includes an internal user system 62 and a manager system 64. In a network segment including the internal user system 62, NSA 70b is installed and the manager system 64 controls an intelligent security management module 50 through GUI. The intelligent security management module 50 comprises ISE (Intelligent Security Engine) 52 and SPM (Security Policy Manager) 54. For the firewall 20, an FSA (Firewall Security Agent) 74a is provided.

In the present embodiment, security agents such as NSA 70, HSA 72 and FSA 74 refer software programs that can search for characteristic patterns of data over the network without intervention of the manager to perform automatic analysis and securing tasks according to a predetermined schedule. The software agents can also perform some other services. The security agents, based on the analyzed characteristic patterns, produce and transmit a security alert message to one or both of communicating devices and the security manager.

Each of the security agents 70, 72 and 74 is situated within the system monitors and acts on its environment to pursue an agenda independent of other software agents. The use of software agents provides advantages in that a separate independent agent may be created to monitor a small aspect of the overall network system. Several agents which monitor different aspects of the overall system may then cooperate with one another to provide, in combination, the functionality of a security monitoring tool. Because agents are independent of one another, the implementation is less cumbersome and preferably requires less overall code space. Furthermore, different agents may be easily added, removed, or modified as necessary to fulfill the requirements of network security. The software approach to network security is particularly advantageous because each software agent is independently trainable. Since the independent agents may be vulnerable to attack, encryption can be applied to the agents for protection from unauthorized modification.

NSA 70 and HSA 72 employed in the present embodiment are active agents that operate in cooperation with N-IDS (Network Intrusion Detection System) and H-IDS (Host-IDS), respectively, and produce alert messages in response to suspicious traffic and known attacks. NSA 70 confronts threats against network security issue and provides analysis of suspicious traffic and alert messages to known attacks. HSA 72 reacts to threats associated with resources of a server within the network. HSA 72 has dedicated information to the function of servers and performs expert security functions. Further, HSA 72 actively responds to a request from ISE 52, and intelligently performs analysis of system status and activities and securing functions. Moreover, NSA 70 and HSA 72 apply a new detection signature by ISE 52 to perform the monitoring and alerting functions. NSA 70 and HSA 72 use a misuse algorithm for the detection of an intrusion, which searches for a set of known attacks and reports the result to SPM 54. NSA 70 delivers all traffic in a reduced form to ISE 52, and ISE 52 then performs anomaly detection based on the delivered traffic. For example, NSS 70 and HSA 72 forward all the reduced traffics and events to ISE 52 every time each session is over. Suspicious traffic and events transferred from NSA 70 and HSA 72 to ISE 52 are subject to correlation and causation analysis by ISE 52, while the reduced traffic and events are pattern-analyzed by ISE 52, which will be explained in detail below.

Misuse detection attempts to match observed behavior against known intrusive behavior patterns and represents the essential nature of a known attack in such a way that variations on that attack can be distinguished from normal behavior. A variety of techniques may be used to model and recognize attack patterns, such as expert systems, signature analysis, state-transition analysis, Petri nets, and genetic algorithms. For the misuse detection, pattern matching, stateful inspection and rule-based solutions may also be used.

Pattern matching method determines if an object to be analyzed matches given factors. For instance, suppose that the object to be analyzed is network packet, the given packet has a length per packet of more than one hundred, protocol is TCP, whose flag is ACK/PSH, and ‘hackerTool.exe’ is included in possessed data. The pattern matching technique examines each of network packets according to a sequence as follows.

if (PACKET.LEN > 100)

if (PACKET.PROTOCOL == TCP)

if (PACKET.FLAG == ACK | PSH)

if (PACKET.DATA == “hackerTool.exe”)

DETECT = SUCCESS;

The stateful inspection is useful in ensuring the accuracy of detection rather than directly used in detecting some attacks. For instance, if an intrusion detection system (IDS) makes SUCCESS_MATCHING through the pattern matching method, the stateful inspection examines a session table in order to see whether attacked host has been actually damaged. In order for a host to be actually attacked, a session connection must be established between the attacker and the target host before the attack packet. Therefore, if there is no information about the establishment of a session in the table, the attack from the intruder is not received by the target host and there is no damage to the host. The stateful inspection of the present invention can solve a problem of prior-art false-positive errors that recognize an alert as an attack whenever a network packet matched to an attack signature is found.

The anomaly detection attempts to model the expected behavior of objects (users, processes, network hosts and the like). Any action that does not correspond to expectations is considered suspicious. The anomaly detection is required to be capable of differentiating normal user behavior, anomalous acceptable behavior, and intrusive behavior. Techniques used in the anomaly detection include profile-based detection, statistical measures, rule-based solutions, and neural networks. It is preferable to use clustering-based anomaly detection or solutions employing a decision tree, which will be explained in detail below.

FSA 74 is an active agent that adopts modified security policy according to the decision and analysis of ISE 52 and SPM 54, and makes the firewall react accordingly. In order to block traffic from the attackers, FSA 74 applies a security policy to the firewall 20 based on information transferred from SPM 54.

The intelligent security system 100 of the present invention includes an intelligent security management module 50 comprising ISE 52 and SPM 54.

ISE 52 is one of the analysis engines which analyzes alert messages from agents installed within each of individual security systems, determines if there if an attack and generates a signature through learning. ISE 52 performs a correlation analysis for minimizing false-positive errors, a causation analysis for minimizing false false-negative errors, and a pattern analysis for generating new detection signatures. The correlation analysis is to analyze correlation among alerts from each of the agents together with information on the system, network topology and application, and makes a precise decision. The causation analysis examines and finds out the causes of occurred events based on suspicious information transferred from the agents and a given scenario. The pattern analysis generates new signatures through self-analysis and learning against unknown attacks and suspicious information. ISE 52 and SPM 54 are installed integrally with the firewall 20, and ISE 52 has a pattern analysis module that confirms any problems in traffic and a learning machine that infers events being likely occurred.

SPM 54 applies decisions from ISE 52 to individual security systems and manages security policies. To the confirmed attacks, SPM 54 instructs the application of dynamic policy to associated agents, and applies, to the agents, dynamic security policies according to a change of services provided by hosts and the detection signatures generated by ISE 52. Further, SPM 54 determines how all the collected security policies should be applied and managed, and decides and manages the level of operation of security alarms.

Work Flow

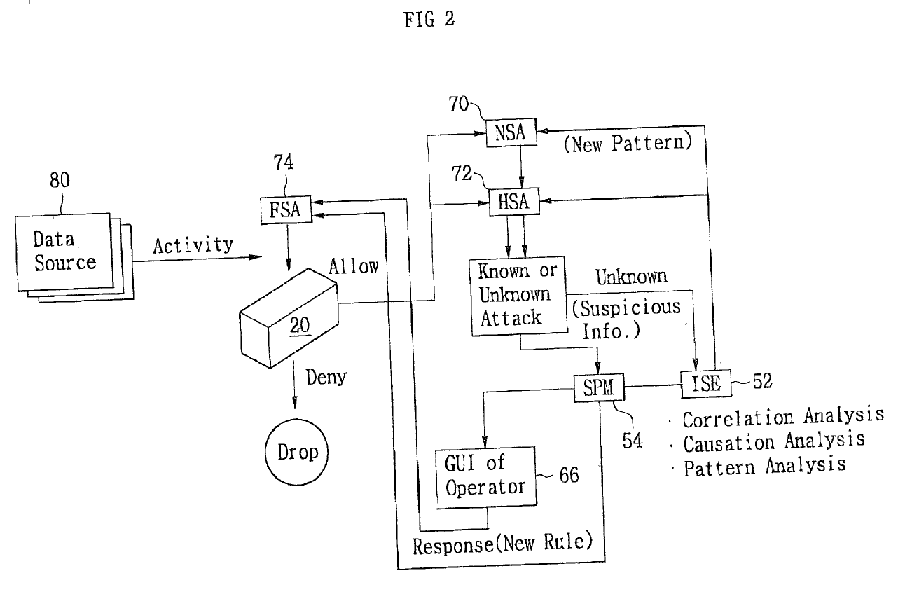

As explained, the firewall 20, independent active agents NSA 70, HSA 72, FSA 74, ISE 52, SPM 54 and policy manager 64 actively cooperate with each other to form an intelligent and integrated security system. The overall security operation is shown in FIG. 2. Referring to FIG. 2, agents NSA 70 and HSA 72 detect known attacks, suspicious information and traffic, and generates a report to ISE 52 and SPM 54. SPM 54, when receiving a detection of an evident attack, applies a new rule to FSA 74 to make the firewall 20 block traffic from the attack data source 80.

To the attacks, suspicious traffic and information required to be analyzed, ISE 52 determines if there is an attack based on a given scenario and through correlation and causation analysis. When an attack is not covered by the correlation and causation analysis, the pattern analysis module of ISE 52 performs an anomaly detection and, if detected as an attack and the attack is an unknown pattern, a new signature is generated through a learning process. The generated signature is transferred to NSA 70 and HSA 72, so that more rapid confrontation in response to future attacks of the same pattern is made possible. At the same time, when the new pattern of attack is recognized, a new or modified rule is given to FSA 74 through SPM 54 so that traffic from the attacker 80 can be blocked.

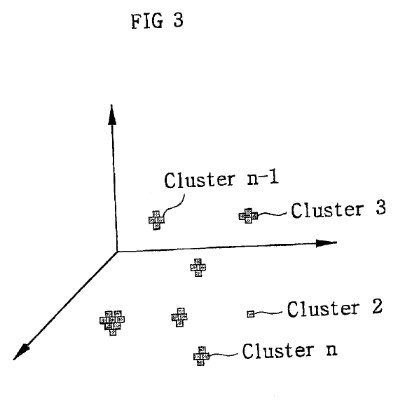

According to one embodiment of the present invention, the learning of a new pattern of attack is performed by using a clustering technique as shown in FIG. 3 and by depending on services (HTTP, FTP, TELNET and the like). The clustering technique uses session information as measures. The session information may include session duration time, start time, end time, the number of packets received by source, the number of packets received by destination, and the status of a TCP flag upon termination. Clustering is carried out by matching a reduced format of the session information onto a three-dimensional space as shown in FIG. 3. Supposing that a single reduced information corresponds to one dot (hatched rectangle) in FIG. 3, most of normal sessions are located at a certain cluster-n. This is called a normal profile. When a session belongs to none of the clusters or is farther distant than a threshold from the normal profile, this session is regarded as abnormal. This clustering process corresponds to the learning process to the unknown attacks.

Intelligent Security Engine

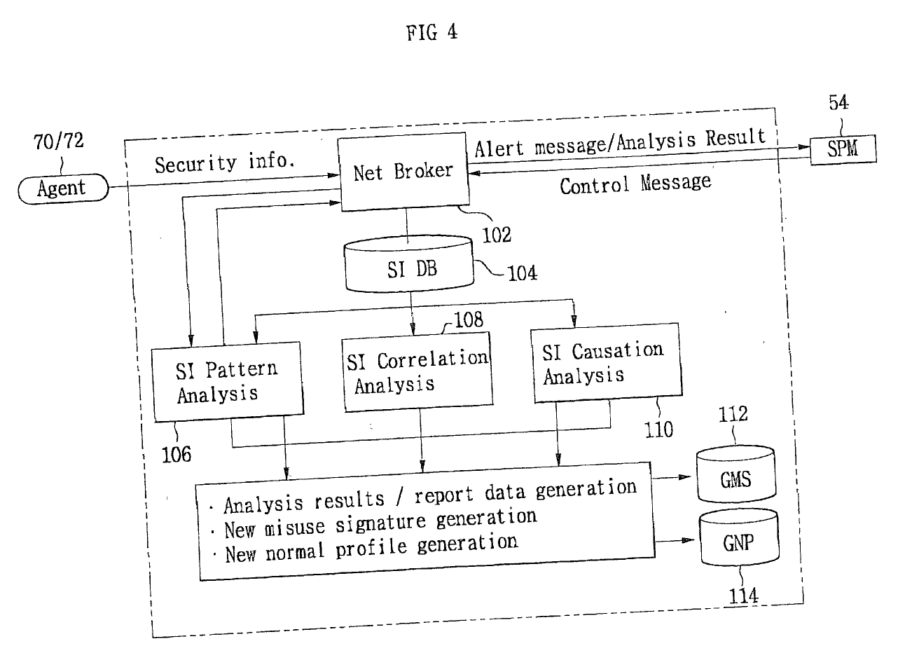

FIG. 4 is a block diagram showing functions and operations of the ISE 52 suitable for use in the intelligent and integrated security system of an embodiment of the present invention.

Security information (SI), i.e., alerts from independent agents 70 and 72, is received by a net broker 102 and stored into a SI database 104. The net broker 102 undertakes communication gateway, encryption and authentication and is installed in each of the agents (SPM, HSA, NSA, GUI) as a separate execution module. Each of the agents transfers necessary information to its own net broker when communicating with another agent, and the net broker of the transmitting agent encrypts and delivers the information to the receiving agent. The net broker in the receiving agent, decrypts and transfers the received information to the receiving agent. A decision is made by performing pattern analysis 106, correlation analysis 108 and causation analysis 110 on SI information received by the net broker 102. A detailed description of the analysis will follow. Based on the decision, a report is generated, and a new type of normal profile and signature (e.g., new pattern of misuse signature) are generated through a learning process. Generated data are stored in GMS (Global Misuse Signature) database 112 and GNP (Global Normal Profile) database 114, and analysis results and alert messages are transferred to SPM 54 through the net broker 102. SPM 54 sends, based on the received analysis results, security management messages to the net broker 102.

Security Policy Manager

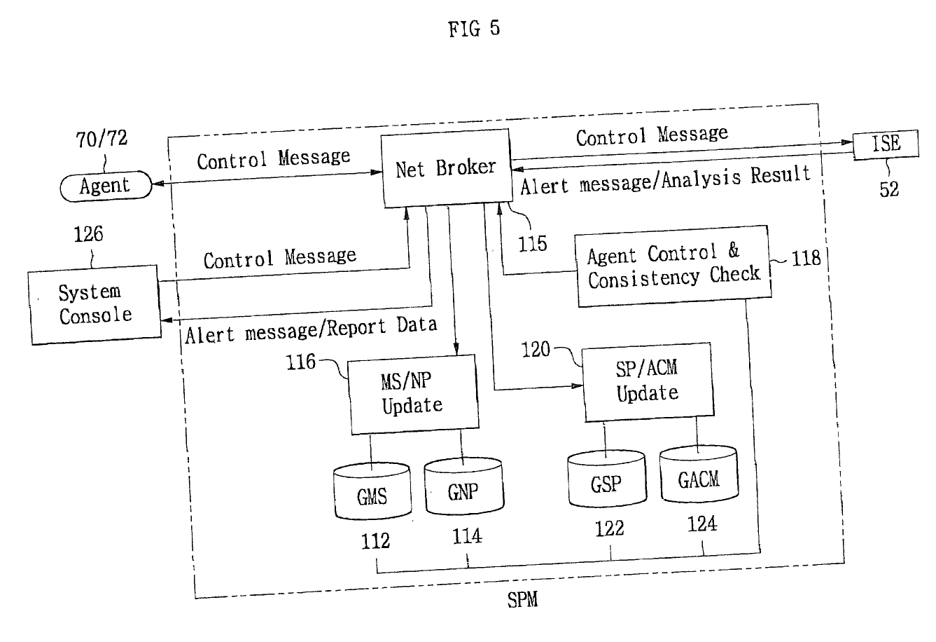

FIG. 5 is a block diagram for illustrating functions and operations of the SPM 54 suitable for use in the intelligent and integrated security system according to an embodiment of the present invention.

Referring to FIG. 5, a net broker 115 of SPM 54 sends to ISE 52 a security control message based on analysis results and alert messages from ISE 52, and with regard to confirmed attacks, transfers a control message to associated agents 70 and 72 so that dynamic security policy can be applied. The net broker 115 delivers alert messages and report data to a system console 126, and then the system console 126 sends control messages to the net broker 115. The net broker 115 updates misuse signature (MS) and normal profile (NP) and stores them into GMS database 112 and GNP database 114. Further, the net broker 115 updates security policy (SP) and access control model (ACM) at step 120 and stores them into GSP database 122 and GACM database 124. Based on data stored in databases 112, 114, 122 and 124, an agent control signal and consistency check result are generated at step 118 and delivered to the net broker 115.

Pattern Analysis

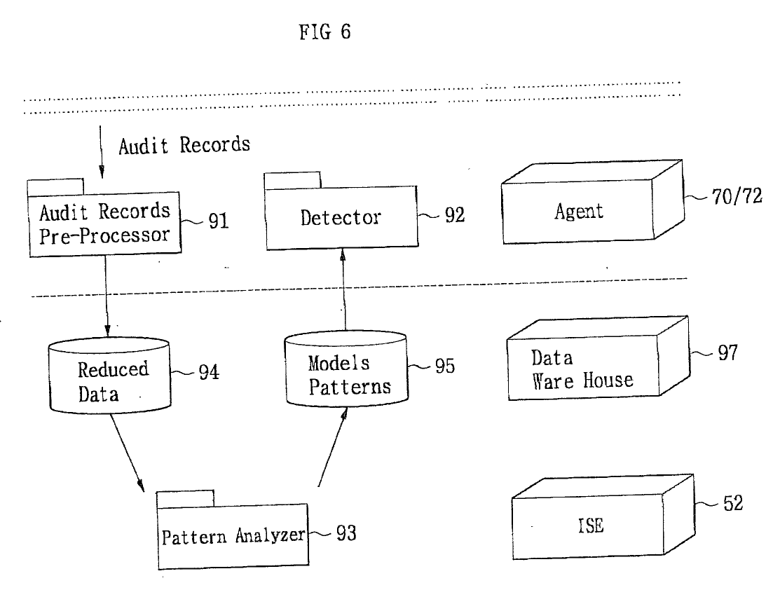

The intelligent and integrated security system includes a pattern analysis module that analyzes network traffics and system calls and generates new patterns. An exemplary structure of the pattern analysis module is illustrated in FIG. 6.

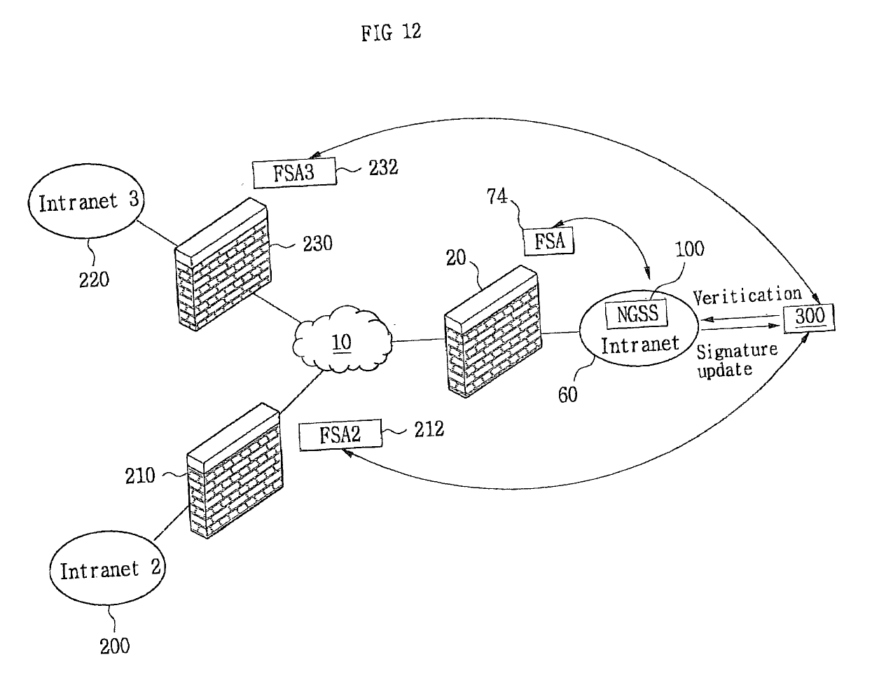

The pattern analysis module 90 can produce a new detection pattern through a self-analysis and a learning process which uses the results of correlation and causation analysis, session information and raw data. In the pattern analysis, different analysis schemes maybe used according to the type of attacks. The generated new patterns are applied dynamically to the detection agents in a relevant site and delivered to a security center (for example, ‘300’ in FIG. 12, discussed later) in a security system for verification of the new pattern. The verified new pattern is updated in real-time to all the detection agents, which may include a remotely located agent as will be explained with reference to FIG. 12.

Referring to FIG. 6, the pattern analysis module 90 includes an audit records preprocessor 91, a detector 92 and a pattern analyzer 93, and carries out a clustering based anomaly detection and an analysis using a decision tree with respect to network traffics.

The audit records preprocessor 91 transforms the audits (e.g., network traffics and system calls) into a format that the detector 92 and the pattern analyzer 93 can recognize. The detector 92 performs an intrusion detection function based on models generated by the pattern analyzer 93. The pattern analyzer 93 improves the detection efficiency by producing new patterns and models through the analysis of the transformed information from the preprocessor 91. Analysis methods in the pattern analyzer 93 include:

an anomaly detection using a decision tree to the network traffic; in which a decision tree having as a class label, a destination port for normal data is generated, and if a destination port for input data and the class label of the generated decision tree is different, it is detected as an attack; and

a clustering based anomaly detection to the network traffic; in which unlabeled data is clustered, and when input data comes, it is searched for the nearest cluster to the clustered data, and if the nearest cluster is abnormal, it is detected as an attack.

In FIG. 6, a data warehouse 97 stores the transformed data from the audit records preprocessor 91 and the patterns and models generated by the pattern analyzer 93.

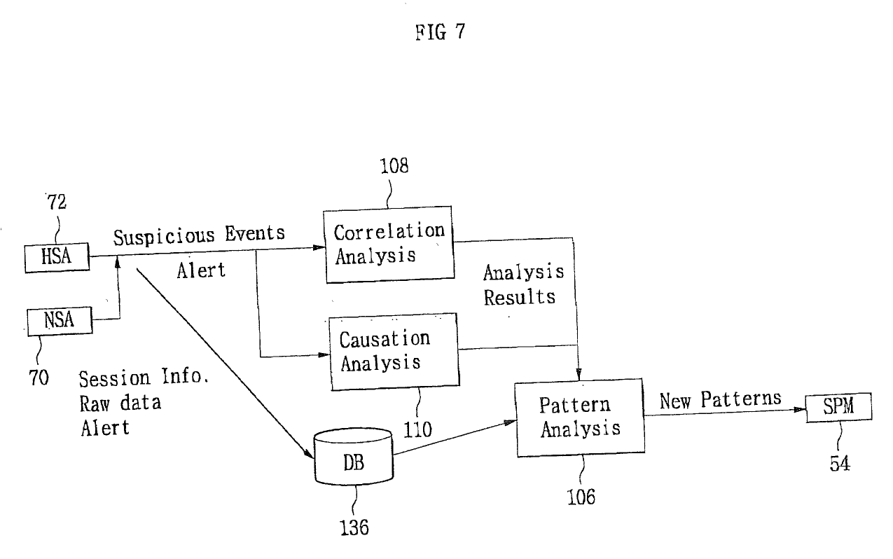

FIG. 7 is a block diagram for illustrating a data flow during the security information pattern analysis. Suspicious events and alert messages transferred from individual security agents such as NSA 70 and HSA 72 are used in the correlation analysis 108 and the causation analysis 110. The alert messages are stored in a database 136 and used, together with session information and raw data, in the pattern analysis 106. The results of the correlation analysis 108 and the causation analysis 110 are used in the pattern analysis 106. New patterns generated by the pattern analysis 106 are transferred to SPM 54.

Correlation Analysis

Correlation refers an analysis to perform a collective analysis of a certain event with reference to other events, when it is impossible to predict or draw a result from an event.

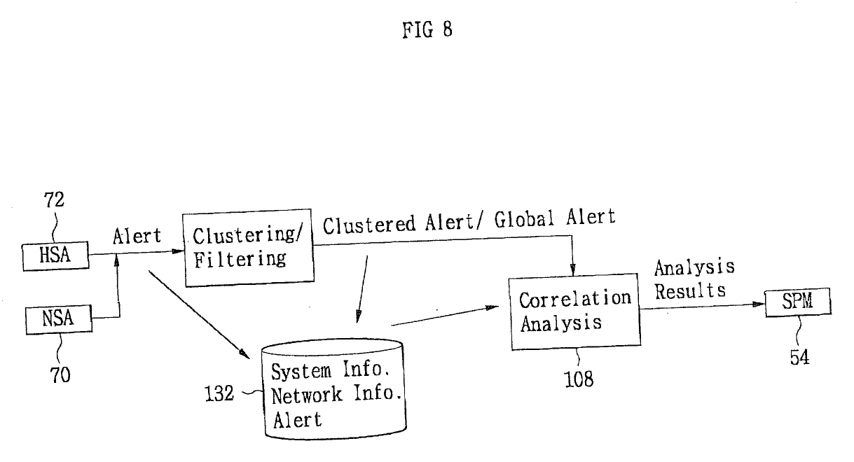

FIG. 8 is block diagram showing a data flow when the correlation analysis is carried out.

Alert messages transferred from NSA 70 and HSA 72 are clustered and/or filtered. In this process, the clustering means collecting events to see the correlation thereof when both NSA 70 and HSA 72 detect events, and is different form the clustering used in the pattern analysis explained previously. The clustering for the correlation analysis groups events until they exceed a certain threshold, and the clustering and filtering may be performed either separately according to the events or collectively. In the correlation analysis 108, system information, network information and alert messages, which are stored in database 132 after being received from NSA 70 and HSA 72, may also be used. The result of the correlation analysis 108 is transferred to SPM 54.

One example of the correlation analysis is described when a malicious attack scans, with automated tools, vulnerable points of any servers in order to intrude the servers in the target network.

The attack scenario of the attacker maybe presumed: (1) Setting the target of the scanning to be the overall hosts in the target network; (2) Confirming if a port is open, which is used by a corresponding process, in order to see if the target process is under running; (3) Sequentially scanning several hosts rather than single host in order to prevent detection by an intrusion detection system; and (4) For the scanning tool, FIN-SCANNER (a tool to confirm if a certain port of the target host is open by sending data with only FIN flag set in TCP header) is used.

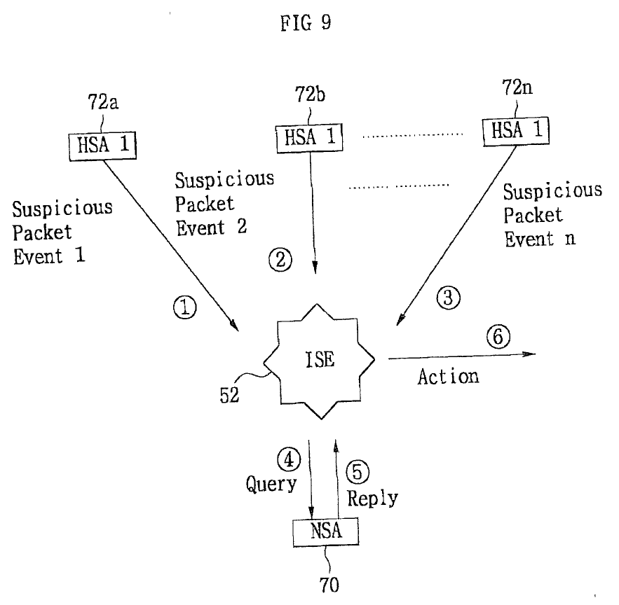

A detection procedure against this attack by using the explained correlation analysis is illustrated in FIG. 9. Right after the attacker sends, through the FIN_SCANNER tool, a packet to host to which HSA is running, HSAs 72a, 72b, . . . 72n inform ISE 52 that a packet with the FIN flag set has been arrived without any preliminary proceedings (1, 2, 3). Here, the ‘preliminary proceeding’ refers to a session establishment process that TCP must pass by in order to transmit and receive data. A normal session can neither transmit nor receive any data with omitting this preliminary process. ISE 52 receives the same report from all the HSAs running within the network. ISE 52 identifies that the identical plural events occurred in the plural hosts are from the same entity or sender. ISE 52 sends a query to NSA 70 on if the events are occurred in HSA that is not running (4). NSA 70 gives a response to ISE 52 on the query (5). ISE 52 detects that the current scanning events towards the whole network and accordingly performs a confrontation action (6).

According to the correlation analysis of an embodiment of the present invention, a global view is provided and the false positive error can be minimized. For instance, suppose that a variant signature of variant CodeRed worm ‘GET/scripts/root.exe?/c++dir/1.0’, and a current system of a target of the attack runs on AIX operation system and a web server of IBM Web Sphere. Of course, there is no other tools for defending the attack. The CodeRed worm can affect only systems operated based on some version of Microsoft NT and Internet Information Server (IIS). Therefore, the attack illustrated above is critical but the target system of the attack is not vulnerable to the CodeRed worm. In other words, an actual attack can not happen. If an alert message to this kind of attack is delivered to the intrusion detection system, this is the false positive error.

Causation Analysis

The causation analysis used in an intelligent and integrated security system of an embodiment of the present invention refers to an analysis technique that confirms if occurred results are from a normal process by analyzing the causes of the results.

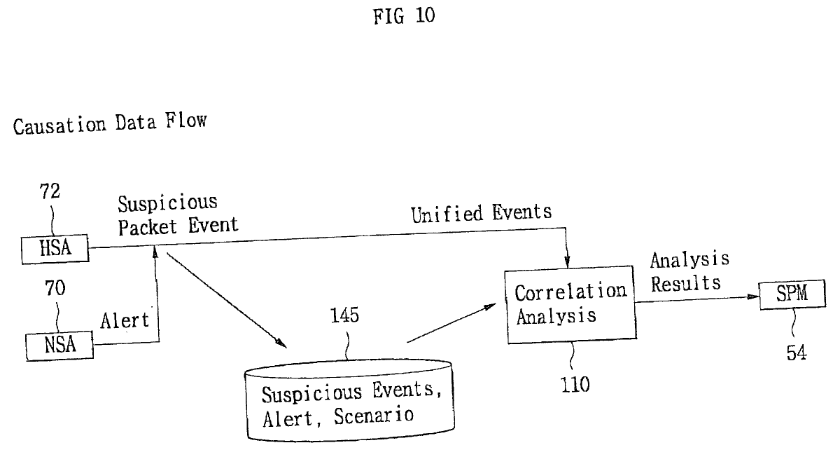

FIG. 10 is a block diagram showing a data flow in the causation analysis.

Causation analysis 10 is performed by using unified events to suspicious packet events from NSA 70 and HSA 72, and suspicious events, alerts and scenarios stored in database 145, and the analysis result is transferred to SPM 54.

One example of the causation analysis is explained with reference to a case where a malicious attacker intrudes a target server and generates a user account or ID.

The likely attack scenario is as follows: (1) Logging into a target host through a bug of a vulnerable process of the target server; (2) Finding a password for a root user through e.g., a ‘password-cracking program’; and (3) Generating a new user ID after acquiring the root authority.

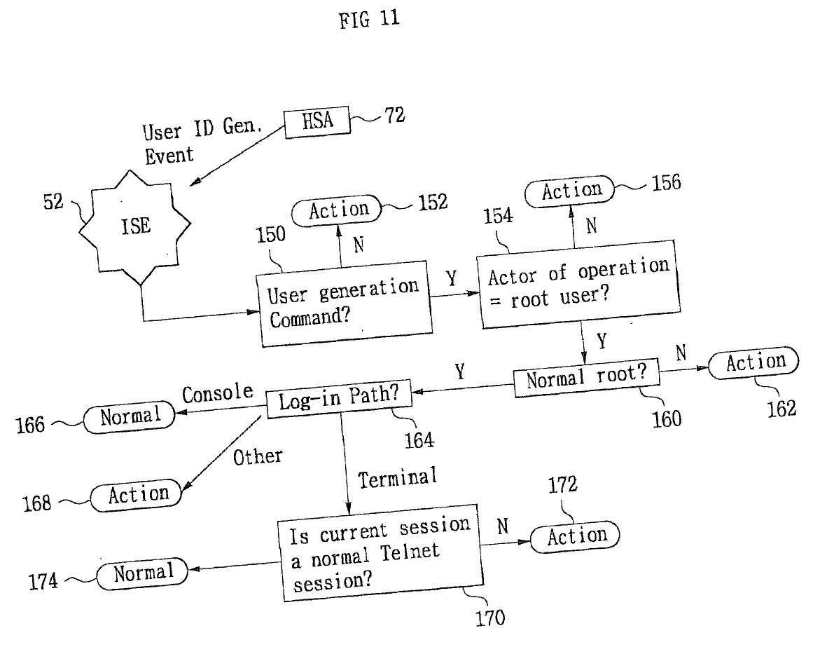

The detection process to this kind of attack by the causation analysis is illustrated in FIG. 11.

Right after when the attacker generates the new user ID, HSA 72 informs ISE 52 that a significant event has been occurred. Receiving a report of the generation of user ID from HSA 72, ISE 52 first of all confirms if the user uses a normal user generation command in the operation (step 150). If the command is not normal, a confrontation action is performed (step 152). If normal, ISE 52 confirms if the actor of the operation is a root user (step 154). When the actor is not a root user, a confrontation action is performed (step 156). If it is confirmed that the actor is a root user, ISE 52 examines if the authority of the root user was acquired through a normal procedure (step 160). If the procedure is not normal, a confrontation action is performed (step 162). When the acquisition of root authority is through normal procedure, ISE 52 confirms if the login path is from a terminal or a console (step 164). When the login path is through the console, it is regarded a normal event (166), while if the login path is from a terminal, ISE 52 confirms again if the user session of the operator is a normal telnet session (step 170). Since the generation of a user ID belongs exclusively to the root user through a console or a telnet session, to the login path other than the console or normal telnet session a confrontation action is performed (step 168). If the session is not the normal telnet session, which represents that the generation of user ID is through a certain port occupied by a process, a confrontation action is performed (step 172). If the login path is through the normal telnet session, the event is regarded as normal (step 174).

According to the causation analysis of the present invention, the false positive ratio can be significantly reduced. For example, suppose that an attack pattern is recorded by extracting a signature in order to detect BOF vulnerability that a certain daemon of a certain O/S has in a conventional IDS. Further, suppose that the daemon of an actually attacked victim host generates a core dump file and permits the attacker a root shell. Because of the nature of misuse detection, even to data that is not actually attacked, a network IDS alerts this occurrence so long as there exists a part identical to the signature. However, in the intelligent security system of the present embodiment, when data identical to the signature is found, it is examined if a core dump file is generated at the attacking point by the host daemon. If the daemon is not affected due to e.g., a patch or other reasons, the security system ignores this kind of attack. False positive errors may be reduced by a variety of detection scenarios.

Moreover, by using the causation analysis, it is possible to reduce the false negative ratio that existing security products performing ID can not find out. For instance, suppose that a malicious normal or insider user comes to find a root password of a certain host. When the password is not exploited through a cracking or vulnerability but by carelessness of a manager, conventional IDS can not detect this and may regard the action of the malicious normal user as a normal event. Generally, a malicious user having the root authority takes a series of common activities of, for example, installing a backdoor program for future login or a sniffing program. At this time, the malicious user produces a hidden directory in the system in an attempt to install the backdoor program or programs necessary for the sniffing from somewhere (mostly from his own host) and then deletes the log. The series of actions are normalized or patterned in the intelligent security system of the present invention, and an alert message is issued against the events that conventional security products regard as normal. Therefore, the false negative error can be minimized.

Remote Signature Update

FIG. 12 is a block diagram for illustrating a remote signature updating process according to an embodiment of the present invention.

The intelligent security system 100 (denoted as NGSS (Next Generation Security System) in FIG. 12) in an internal network 60 generates a new signature which is in turn applied to FSA 74 within the network 60. The new signature is verified at a security center 300. A verified signature is applied to remotely located agents such as FSA₂ 212 and FSA₃ 232 within secure external networks Intranet₂ 200 and Intranet₃ 220. The updated signature is used by associated firewalls 210 and 230 in blocking the traffic from an attacker. Therefore, the security policy of the intelligent security system of the present embodiment can be extensively applied to other intranets located remotely and connected by the open network 10.

As explained so far, an intrusion or an attack can be precisely detected and real-time reaction against the attack is made possible. Further, by integrating the separate and independent security components, prior drawbacks of the components are resolved and the efficiency of the information security can be maximized.

Moreover, the present invention provides a distributed security environment based on a number of agents, which leads to an improvement in the performance of the security system. Further, the correlation analysis, causation analysis and pattern analysis schemes, alone or in combination thereof, can minimize the detection failures and make possible an intelligent and efficient intrusion detection and allow for proper reaction against detected intrusions or attacks.

Further according to the present invention, since a signature is generated through a self-learning process, a new detection pattern to an unknown attack can be applied dynamically and in real-time, and a detection policy can be modified and applied in real-time through a performance monitoring of the system.

In the drawings and specification, there have been disclosed typical preferred embodiments of this invention and, although specific terms are employed, they are used in a generic and descriptive sense only and not for purposes of limitation. There may be other embodiments of this invention which are not specifically illustrated, and the scope of this invention is set forth in the following claims.

What is claimed is:

1. An intelligent and integrated security system, comprising:
a firewall for interconnecting and controlling access between external and internal networks;
a plurality of security agents for monitoring a data flow and system calls over the internal network;
an intelligent security engine (ISE) for analyzing an alert message, a traffic information and an event information transferred from the plurality of security agents, to decide if there is an attack and to generate a signature through a learning process; and
a security policy manager (SPM) for managing and applying a security policy to each of the plurality of security agents based on a decision of the ISE.

2. The security system claimed in claim 1, wherein the ISE performs a correlation analysis and a causation analysis on a suspicious traffic, a suspicious event and a detection message transferred from the plurality of security agents.

3. The security system claimed in claim 1, wherein the ISE comprises a pattern analysis module which performs a pattern analysis on all traffic and events transferred from the plurality of security agents.

4. The security system claimed in claim 2, wherein the ISE comprises a pattern analysis module which performs a pattern analysis on all traffic and events transferred from the plurality of security agents, said pattern analysis module generating a new detection pattern based on the results of the correlation analysis and causation analysis, a session information and raw data.

5. The security system claimed in claim 3 or 4, wherein the pattern analysis module comprises a pre-processor for data-transforming an audit produced from the plurality of security agents, a pattern analyzer for analyzing the transformed audit data and generating a new pattern and model, and a detector for detecting an intrusion based on the generated model.

6. The security system claimed in claim 3 or 4, wherein the pattern analysis module performs an anomaly detection by using clustering with regard to network traffic and a misuse detection pattern generation by using an expert system.

7. The security system claimed in claim 2, wherein the correlation analysis analyzes correlation among alerts transferred from the plurality of security agents, and examines a related system information, a network topology, and application information.

8. The security system claimed in claim 2, wherein the causation analysis analyzes causes and results of events based on a scenario with respect to suspicious information transferred from the plurality of security agents.

9. The security system claimed in claim 1, wherein the plurality of security agents include a network security agent (NSA) for analyzing a suspicious traffic and providing a network security function, and a host security agent (HSA) for reacting to threats associated with resources of a server within the network.

10. The security system claimed in claim 1 or 9, wherein the plurality of agents include a firewall security agent (FSA) for adopting a security policy transferred from the SPM and causing the firewall to block traffic from an attacker.

11. The security system claimed in claim 9, wherein the NSA and HSA perform a misuse detection to a known attack and transfer all the traffic and events to the ISE.

12. The security system claimed in claim 11, wherein the misuse detection uses one of an expert system, a signature analysis, a state-transition analysis, Petri nets, a genetic algorithm, pattern matching, a stateful inspection and rule-based solution.

13. The security system claimed in claim 12, wherein the pattern matching examines if an object to be compared is identical to a predetermined pattern.

14. The security system claimed in claim 12, wherein the stateful inspection examines a session table in order to determine if a target host of an attack is actually damaged.

15. The security system claimed in claim 3 or 4, wherein the anomaly detection performed by the ISE uses one of a profile-based detection, statistical measures, a rule-based solution, a neural network, a clustering-based anomaly detection and a solution employing a decision tree.

16. The security system claimed in claim 3 or 4, wherein the ISE generates a new signature through a learning process when an attack determined by the anomaly detection of the pattern analysis module is an unknown attack.

17. The security system claimed in claim 16, wherein the learning process is a clustering process which includes a step for matching reduced session information onto a three dimensional space.

18. The security system claimed in claim 17, wherein the reduced session information includes a session duration time, a start time, a termination time, a number of packets received by a source, a number of packets received by a destination, and a status of a TCP flag upon termination.

19. The security system claimed in claim 7, wherein the correlation analysis uses a clustering technique which groups events until an event group exceeds a threshold.

20. An intelligent and integrated security system comprising:
a firewall for interconnecting and controlling access between external and internal networks;
a network security agent (NSA) for analyzing a suspicious traffic so as to react to a threat related to a network security;
a host security agent (HSA) for protecting resources of servers located within the network and analyzing a status and activity of the system;
an intelligent security engine (ISE) for analyzing an alert message, a traffic information and an event information transferred from the NSA and HSA to decide if there is an attack and to generate a signature through a learning process;
a security policy manager (SPM) for managing and applying a security policy to each of the plurality of security agents based on a decision of the ISE; and
a firewall security agent (FSA) for adopting the security policy of the SPM and causing the firewall to block a traffic from an attacker,
wherein the ISE carries out a correlation analysis and a causation analysis based on a suspicious traffic and event transferred from the NSA and HSA, and performs a pattern analysis on all the reduced forms of traffics and events delivered from the NSA and HSA.

21. The security system claimed in claim 20, wherein the pattern analysis performs an anomaly detection by using a decision tree.

22. The security system claimed in claim 20, wherein the pattern analysis performs an anomaly detection by a clustering technique.

23. The security system claimed in claim 20 or 22, wherein the pattern analysis carries out a misuse detection by using an expert system.

24. The security system claimed in claim 20, further comprising a security center for verifying the new signature generated by the ISE.

25. The security system claimed in claim 23, wherein the security center applies the verified signature to a remotely located FSA for a firewall that belongs to a remote external network.

26. An intelligent security engine comprising:
means for receiving all reduced forms of traffic and events from a security agent and receiving a suspicious traffic and event from the security agent;
means for performing a correlation analysis and a causation analysis on the suspicious traffic and event received by the receiving means;
a pattern analysis module for analyzing patterns of all the reduced forms of traffic and events received by the receiving means;
means for generating a new signature based on the results of the correlation analysis, the causation analysis and the pattern analysis;
means for deciding if there is an attack based on the results of correlation analysis, the causation analysis and the pattern analysis; and
means for transferring the decision and the new signature to a security policy manager.

27. The intelligent security engine claimed in claim 26, further comprising a learning machine for inferring an event or traffic that is likely to occur.

28. The intelligent security engine claimed in claim 27, wherein the learning machine matches a session information onto a three dimensional space and groups the session information into a cluster.

29. The intelligent security engine claimed in claim 26, wherein the pattern analysis module comprises a pre-processor for data-transforming an audit produced from a plurality of the security agents, a pattern analyzer for analyzing the transformed audit data and generating a new pattern and model, and a detector for detecting an intrusion based on the generated model.

30. The intelligent security engine claimed in claim 29, wherein the pattern analysis module performs an anomaly detection by using clustering with regard to network traffic and a misuse detection pattern generation by using an expert system.

31. The intelligent security engine claimed in claim 26, wherein the correlation analysis analyzes correlation among alerts transferred from a plurality of the security agents, and examines a related system information, a network topology and application information.

32. The intelligent security engine claimed in claim 26, wherein the causation analysis analyzes causes and results of events based on a scenario with respect to suspicious information transferred from a plurality of the security agents.
